(19) United States
(12) Patent Application Publication
(10) Pub. No.: US 2022/0097139 A1
(43) Pub. Date: Mar. 31, 2022

(54) METHOD FOR THE PRODUCTION OF PARTS MADE FROM METAL OR METAL MATRIX COMPOSITE AND RESULTING FROM ADDITIVE MANUFACTURING FOLLOWED BY AN OPERATION INVOLVING THE FORGING OF SAID PARTS

(71) Applicant: SAINT JEAN INDUSTRIES, Saint Jean D'ardieres (FR)

(72) Inventors: Emile Thomas DI SERIO, Chenas (FR); Lionel DUPERRAY, La Chapelle De Guinchay (FR); Frédéric PERRIER, Lyon (FR); Christophe DESRAYAUD, Lyon (FR)

(73) Assignee: SAINT JEAN INDUSTRIES, Saint Jean D'ardieres (FR)

(21) Appl. No.: 17/549,171

(22) Filed: Dec. 13, 2021

Related U.S. Application Data
(63) Continuation-in-part of application No. 15/305,189, filed on Oct. 19, 2016, now abandoned.

(30) Foreign Application Priority Data
Apr. 29, 2014 (FR) 1453875

(51) Int. Cl. B22F 10/10; B33Y 10/00; B33Y 40/20; B33Y 80/00; B21J 5/02

(52) U.S. Cl. CPC B22F 10/10; B33Y 10/00; B21J 5/025; B33Y 80/00; B33Y 40/20

(57) ABSTRACT

A method of manufacturing a piece of metal alloy or of metal matrix composite materials consisting of making a preform by additive manufacturing by adding material in successive layers, and subjecting the preform to a forging operation taking place in a single step and between two dies to deform said preform to a final shape of the piece to be obtained.

### CROSS-REFERENCE TO RELATED APPLICATIONS

This application is a continuation-in-part (CIP) of U.S. application Ser. No. 15/305,189, filed on Oct. 19, 2016, and published on Feb. 16, 2017 as U.S. Publication No. 2017/0043402, which is the National Phase filing under 35 U.S.C. § 371 of International Application No. PCT/FR2015/051087, filed on Apr. 22, 2015, and published on Nov. 5, 2015 as WO/2015/166167 A1, which claims priority to French Application No. 1453875, filed on Apr. 29, 2014. The contents of each of the prior applications are hereby incorporated by reference herein in their entireties.

### FIELD OF THE INVENTION

The invention relates to the technical field of manufacturing pieces of metal or of metal matrix composite, particularly but non-limitingly for making components and equipment for the automobile and aviation sectors.

### BACKGROUND

Additive manufacturing, which enables pieces or parts to be fabricated by fusing (melting together) or sintering successive layers, is developing, the basic concept being defined in U.S. Pat. No. 4,575,330 dating from 1984.

Additive manufacturing is defined by ASTM as being a process of joining materials to make objects from three-dimensional (3D) model data, usually layer upon layer, as opposed to subtractive manufacturing methodologies such as machining, whereby material is removed. It is also the name given to the technology of 3D printing.

That technology has developed to make pieces of metal alloys either by fusing or sintering powder beds, or else by welding wires. Tests on metal matrix composites have shown themselves to be very promising. The technologies used, to mention them non-exhaustively, range from Selective Laser Sintering (SLS) to Electron Beam Melting (EBM) and include Direct Metal Laser Sintering (DMLS) and Laser Metal Deposition (LIVID) or Selective Laser Melting (SLM). Those technologies make it possible to manufacture pieces or parts that are of high geometrical complexity and that have satisfactory mechanical properties, but that result comes at the price of a cycle time that is often lengthy. For each successive layer, the powder must be spread by a roller, and the electron beam or the laser must sweep the entire surface of each layer so as to obtain good cohesion of the powder. To reduce the cycle time, the strategy employed by manufacturers is to increase the power and the number of the beams so as to melt (fuse) or sinter each layer more rapidly, thereby increasing the cost of the manufacturing machine. The metals used are mainly titanium alloys for the EBM technology, but the technologies using laser are more versatile. They make it possible to manufacture pieces of ferrous alloys, of alloys based on titanium, aluminum, cobalt-chromium, nickel, etc., as well as of metal matrix composites (titanium-titanium carbide, aluminum-alumina, aluminum-silicon carbide, etc.).

Unfortunately, pieces or parts obtained by additive manufacturing quite often have residual microporosity. Such microporosity degrades the mechanical properties of the pieces or parts, in particular the ductility and fatigue strength. A Hot Isostatic Pressing (HIP) step, which consists in putting the piece under high pressure and at high temperature, is often necessary to obtain satisfactory fatigue strength.

Pieces or parts obtained by additive manufacturing also have surface roughness that is coarse due to the particle size of the powder used and to the residual trace of the various layers formed during the additive manufacturing.

Such pieces also have a casting microstructure due to the powder melting while the piece is being obtained or made. Such a structure is, in particular, lamellar for alloys based on titanium and does not make it possible to satisfy most specifications for structural aircraft parts. For improved mechanical properties, a bimodal microstructure that is both lamellar and nodular is required. Such a structure can then be obtained only by hot-deformation operations of the forging type, and under costly and specific implementation conditions.

In view of those drawbacks, the Applicant's approach was thus to think about and to find a solution making it possible to mitigate those various problems.

In entirely independent manner and without any relation to additive manufacturing, the Applicant has, since 1983, i.e. since a period corresponding to the that of the above-mentioned US patent, developed a novel concept combining casting and forging technologies for casting and forging a piece of aluminum or of aluminum alloy. That technology was disclosed in European Patent EP 119 365, and it implements a first phase for casting a piece of aluminum or of aluminum alloy in a mold so as to constitute a preform, the preform then being subjected to a forging operation in a die of smaller dimensions and making it possible to obtain the final shape to be obtained with very specific properties indicated in that patent. That “cast-and-forged” technology is sold under the trademark “COBAPRESS” that is now in widespread use globally.

During the forging process in the technology “COBAPRESS”, the preform is subjected to both deformation and pressure.

Indeed, at the beginning of the forging process the preform is deformed gradually up to the obtention of the final shape. As for usual forging process, the amount of this deformation inside the part varies depending on the zone where it is measured. The deformation is more important near the parting line than in other zones.

At the beginning of the forging process, the pressure inside the die cavity starts increasing slowly. At the end of the forging process, this pressure increases significantly to reach its maximum values.

Thanks to these two phenomena, i.e. deformation and pressure increase, we obtain a part with the needed final shape and we can close potential porosities in the casting parts.

Since that period 1983-1984, i.e. over the last thirty years, it has been observed that the solutions brought to remedy the above-recalled drawbacks suffered by additive manufacturing are lengthy and costly, and that no solution has been found for obtaining a bimodal microstructure, which is necessary in a large majority of structural aircraft parts that are made of titanium alloy.

### SUMMARY

Faced with the problems to be solved for additive manufacturing, the Applicant observed that the problem of microporosities that is encountered in such manufacturing is also present during manufacturing of castings.

The approach of the Applicant thus focused on seeking an unexpected combination of the two technologies constituted by additive manufacturing and by cast-and-forged technology, those two technologies being seemingly incompatible even though they have been known since the period 1983-1984.

In entirely unexpected manner, and on the basis of tests conducted by the Applicant, it appeared that implementing a combination of the two technologies is capable of responding to and of remedying the drawbacks observed in additive manufacturing.

A first object of the invention is a method of manufacturing a piece of metal alloy or of metal matrix composite materials, said method comprising:
making a preform by additive manufacturing by adding material in successive layers; and
subjecting the preform to a forging operation taking place in a single step and between two dies defining a die cavity, to deform said preform to the final shape of the piece to be obtained,
   wherein the preform contains at least one first zone, called powder area, in which a powder material is not bonded together or is partially consolidated, and at least one second zone, called shell, comprising bonded material enclosing the powder area, wherein the forging operation is carried out such that the deformation of the preform via the two dies bonds the powder material of the powder area in solid phase, wherein the forging operation is carried out by applying a true strain to the shell superior or equal to 1.5, wherein the pressure inside the die cavity at the end of the forging operation is between 30 MPa and 700 MPa.

In the present text, the term “true strain” corresponds to the natural logarithm of the quotient of current length over the original length, given by the following formula (1):

$${ϵ}_{t} = ln \frac{L}{{L}_{0}} \qquad ( formula ( 1 ) )$$

wherein ϵₜ is the true strain, L₀ is the initial length of the material, and L is the final length of the material. The true strain is used instead of the engineering strain for more accurate definition of plastic behaviour of ductile materials by considering the actual dimensions of such materials.

The solution that has been developed consists in obtaining a piece of metal alloy or of metal matrix composite materials by additive manufacturing so as to form a preform, and then in forging said preform while it is hot, semi-hot, or cold, in a single step implemented between two dies with a view to obtaining the final shape for the piece to be obtained.

The deformation of the preform is global, which means that the preform changes shape during the forging operation so as to match the shape of the forging dies.

A remarkable aspect of the process of the invention is that the powder, in the powder area, is held captive within the preform that has a bonded periphery, which is the shell, produced by additive manufacturing. The powder is then bonded during a single step die forging, which is way quicker than other processes of the prior art.

According to an embodiment, the additive manufacturing of the preform may be carried out by Electron Beam Melting (EBM) which takes place under vacuum. By such process we can avoid having trapped gas inside the part.

Several benefits may be obtained thanks to the process of the invention, such as the saving of a considerable amount of cycle time during the manufacturing of the preform since not all the powder is bonded. Indeed, in the usual additive manufacturing technologies, to sinter or melt the powder, the laser or the electron beam needs to sweep the entire surface of the piece for each layer. By melting or sintering the powder on the outside outline of the preform only, the preform is obtained way more quickly. The preform is constituted by a solid bonded shell holding the partially consolidated or non-consolidated powder captive inside it. In other terms, the obtained preform is in the form of a solid shell filled with non-bonded powder. Forging this preform makes it possible to obtain the final mechanical piece or part.

This technique also offers the advantage of obtaining a microstructure having fine particles since there is no fusion of the internal powder during the preform additive manufacturing. For example, during additive manufacturing of titanium alloy, epitaxial growth of the particles on the lower layer has been observed. Such growth gives rise to a microstructure with rather coarse particles, which is not good for the mechanical properties. With no fusion of the powder, the fineness of the microstructure is preserved. The non-bonded zones of the preform thus give zones with a very fine microstructure on the final piece or part because the bonding takes place in solid phase during the forging step (i.e., solid state forging). Such a fine structure that does not have any crystallographic texture is very good for the static and cyclic mechanical properties of the piece or part.

Another advantage of this technique is the minimization of the residual stress inside the part. In the usual additive manufacturing technologies, the use of the laser or the electron beam to sinter or melt the powder on the entire part create an important residual stress which can lead to distortion of the finished part or to create crucks in this part. To release these residual stresses, a heat treatment is usually carried out after the additive manufacturing of the part.

Thanks to the technique presented by the Applicant and since only the outside outline of the preform is melted, the residual stress can be considerably reduced. The post heat treatment can be avoided.

The resulting piece after the forging step has its final shape, and, after deburring or without deburring, has the functional dimensions to be fit for purpose without requiring additional machining other than of the functional zones with limited tolerance ranges.

In entirely unexpected manner, this method makes it possible to overcome the above-mentioned drawbacks and the limits observed with pieces obtained by additive manufacturing.

The method of the invention may include one or several of the following features, taken individually or according to all technical possible combinations:
the true strain applied to the shell is superior or equal to 1.7;
the true strain applied to the shell is inferior or equal to 8, preferably inferior or equal to 4, more preferably inferior or equal to 3, and even more preferably inferior or equal to 2;
the forging step is carried out by applying a true strain to the powder area superior or equal to 2, provided that the true strain applied to the powder area is superior to the true strain applied to the shell;
the forging step is carried out by applying a true strain to the powder area inferior or equal to 10, preferably inferior or equal to 6, preferably inferior or equal to 3, more preferably inferior or equal to 2.5, provided that the true strain applied to the powder area is superior to the true strain applied to the shell;
the pressure inside the die cavity at the end of the forging operation is between 30 MPa and 400 MPa, more preferably between 100 MPa and 400 MPa, and more preferably between 100 MPa and 300 MPa.
the piece of metal alloy is of an alloy based on iron, aluminum, nickel, titanium, chromium, or cobalt;
the piece of composite materials is of a titanium-titanium carbide alloy, of an aluminum-alumina alloy, or of an aluminum-silicon carbide alloy;
the forging operation for forging the preform obtained by additive manufacturing is performed semi-hot or cold or hot;

As already disclosed above, regardless of the embodiment of the method of the invention, the true strain applied to the powder area is superior to the true strain applied to the shell.

Another object of the invention relates to pieces or parts obtainable by implementing the method of the invention described above.

### BRIEF DESCRIPTION OF THE DRAWINGS

Further features and advantages of the invention will become more apparent from the detailed description to follow, with reference to the appended drawings, in which:

FIG. 1 is a schematic perspective view of a preform having a cubic form, obtained by additive manufacturing, comprising a powder area enclosed within a shell;

FIG. 2 is a schematic side view of the preform of FIG. 1;

FIG. 3 is a photograph of several cubic preforms corresponding to that illustrated in FIGS. 1 and 2;

FIG. 4 is a graph that represents the evolution of the deformation of the powder material (powder area or powder zone) in function of the deformation applied onto the shell by the dies;

FIG. 5 is a photograph of the powder area after the forging operation, when the deformation applied onto the shell by the machine is 1.1;

FIG. 6 is a photograph of the powder area after the forging operation, when the deformation applied onto the shell by the machine is 1.5.

### DETAILED DESCRIPTION

According to the method of the invention, the forging step that combines material deformation and a significant increased pressure at the end of the process, as described previously, makes it possible to reclose and to re-bond the microporosities present in the powder area of the preform by bonding the various layers of the additive structure. This leads to improved ductility and fatigue strength.

Moreover, thanks to the forging step, we can bond the unbonded or partially consolidated powder.

In order to provide more details about the process parameters, the Applicant carried out a set of experimental trials and numerical simulations of the forging of preforms obtained by additive manufacturing.

The test protocol comprises:
a. making testing preforms by additive manufacturing, the testing preforms enclosing unbonded powder material;
b. subjecting the testing preforms to a forging operation taking place in a single step and between two forging dies, by applying different amounts of true strain to the preforms, and
c. cutting the forged parts in and observing the state of the powder zone.

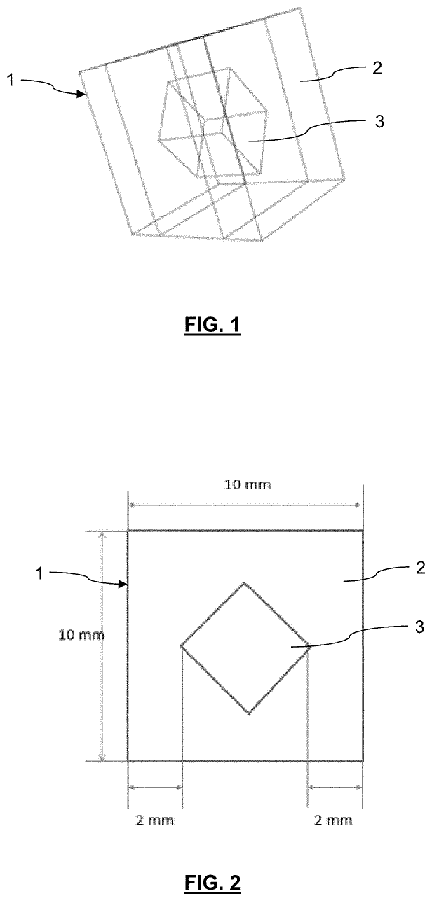

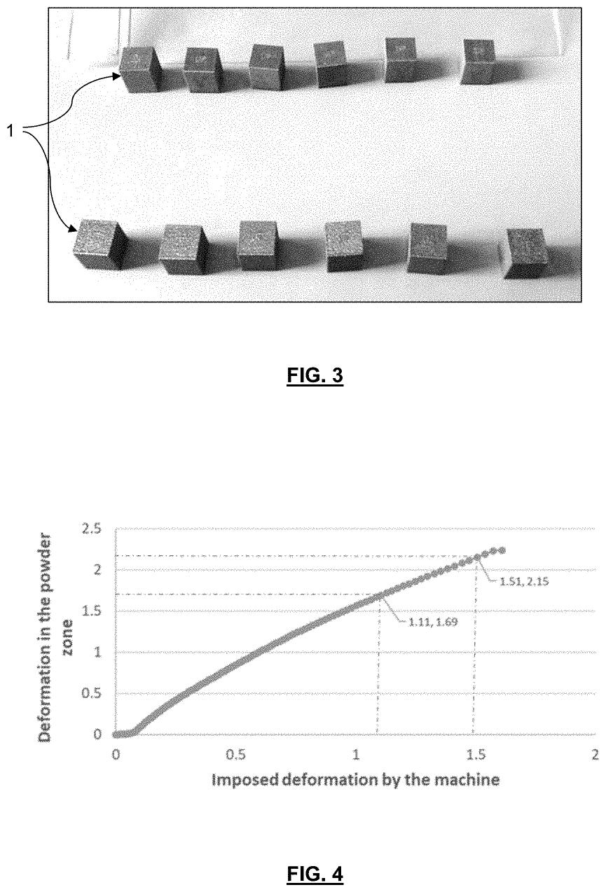

The testing preforms 1 were cubes of 10 mm×10 mm×10 mm. The testing preforms comprised a solid, bonded outer shell 2 formed via direct metal laser sintering (DMLS) additive manufacturing (on a ProX 200 additive manufacturing machine), enclosing an inner cavity 3 filled with non-bonded powder, referred to as powder area or powder zone, as illustrated in FIG. 1, FIG. 2 and FIG. 3. The testing preforms were made of TA6V titanium alloy, also known as Ti-6A1-4V (both the solid and powder zones).

Based on numerical simulations and tests conducted by the Applicant, the true strain in the preform during the forging step must be superior or equal to 1.5.

Indeed, as described previously, during the forging process, different deformation levels occur inside the part.

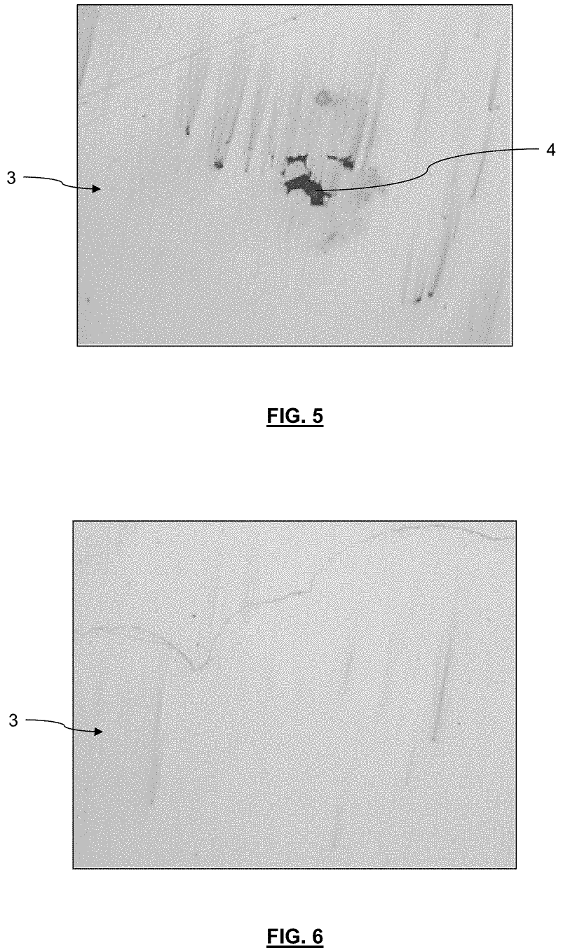

For the tested preforms that were subjected to a die forging machine true strain deformation of 1.1, which corresponds to a true strain of 1.1 for the shell and 1.7 for the powder area, as presented in the graph of FIG. 4, we note that most of the powder is consolidated, but some porosities 4 remain in some regions, as shown in the photograph of FIG. 5.

For the tested preforms that were subjected to a die forging machine true strain deformation of 1.5, which corresponds to a true strain of 1.5 for the shell and 2.1 for the powder area, as presented in the graph of FIG. 4, no defects such as porosities remain in the powder. Rather, (all) the powder in the powder area is fully bonded, i.e. uniformly bonded, as shown in the photograph of FIG. 6.

The upper limit of the true strain in the preform during the forging step may be adapted depending on the dimensions and structure of the preform. For example, the true strain may be about 5, 8, or 10. Preferably, the true strain is inferior or equal to 5.

Regarding the pressure evolution, depending on the forging machine power, the pressure inside the die cavity increases at the end of the forging process and must reach between 30 MPa and 700 MPa, preferably between 30 MPa and 400 MPa, more preferably between 100 MPa and 400 MPa, and more preferably between 100 MPa and 300 MPa. Indeed, as explained previously, the combination of deformation and pressure increase allows to achieve a part of the desired shape wherein potential porosities existing initially in the preform are filled.

Comparatively, document US 2015/0283614 discloses the use of hot isostatic pressing (HIP) or pneumatic isostatic forging (PIF) to consolidate a powder inside a preform obtained by additive manufacturing. These two processes are based on the use of isostatic pressure which need specific facilities such as pressure vessel, gas or liquid to be pressurized, and facilities to increase and control the pressure level. These requirements lead to several constrains especially in terms of part dimensions and productivity. But most importantly, unlike the method of the invention, HIP and PIF processes involve less global deformation of the preform to obtain the final part or piece of the desired shape. Thanks to the forging process presented in the method of the invention, less initial powder density in the powder zone can be used. Indeed, with a large global deformation and a high true strain level the full densification of the powder may be achieved.

In addition, the open porosities (porosities in the shell) are very critical with the HIP and PIF process. Indeed, the use of pressurized gas with open porosities will push this gas inside the part which will create internal porosities due to gas entrapment. Using the forging process presented in the method of the invention we will avoid such problem.

The process presented by the Applicant takes profit of the usual forging process for the consolidation of the powder. Indeed, thanks to the material deformation and the pressure increase phenomena during the forging step the powder is consolidated.

The step of forging between two polished dies also enables the surface roughness to be drastically reduced, thereby making it possible to improve the fatigue strength and the surface appearance.

The tests that have been conducted appear very promising. No indication of either of the technologies known since 1983-1984 could have suggested combining them because the state in which the preform was obtained was different, the preform being obtained by casting in the “cast-and-forged” technology, whereas it is obtained by fusing (melting together) or sintering successive layers in additive manufacturing.

In the context of implementing the invention, the piece may be a piece of metal alloy (based on steel, iron, aluminum, Inconel, nickel, titanium, chromium-cobalt, etc.) or of metal matrix composite materials (titanium-titanium carbide, aluminum-alumina, aluminum-silicon carbide, etc.).

The forging second step of the invention for forging the preform obtained by additive manufacturing may be performed hot, semi-hot, or cold. The dies may optionally be polished.

The above-highlighted advantages and unexpected results with implementing the invention constitute a considerable development in processing pieces of metal or of metal matrix composite that are obtained by additive manufacturing.

1. A method of manufacturing a piece of metal alloy or of metal matrix composite materials, said method comprising:
making a preform by additive manufacturing by adding material in successive layers; and
subjecting the preform to a forging operation taking place in a single step and between two dies defining a die cavity, to deform said preform to the final shape of the piece to be obtained,
wherein the preform contains at least one first zone, called powder area, in which a powder material is not bonded together or is partially consolidated, and at least one second zone, called shell, comprising bonded material enclosing the powder area,
wherein the forging operation is carried out such that the deformation of the preform via the two dies bonds the powder material of the powder area in solid phase,
wherein the forging operation is carried out by applying a true strain to the shell superior or equal to 1.5,
wherein the pressure inside the die cavity at the end of the forging operation is between 30 MPa and 700 MPa.

2. A method according to claim 1, wherein the true strain applied to the shell is superior or equal to 1.7.

3. A method according to claim 1, wherein the true strain applied to the shell is inferior or equal to 8, preferably inferior or equal to 4, more preferably inferior or equal to 3, and even more preferably inferior or equal to 2.

4. A method according to claim 1, wherein the forging step is carried out by applying a true strain to the powder area superior or equal to 2, provided that the true strain applied to the powder area is superior to the true strain applied to the shell.

5. A method according to claim 1, wherein the forging step is carried out by applying a true strain to the powder area inferior or equal to 10, preferably inferior or equal to 6, preferably inferior or equal to 3, more preferably inferior or equal to 2.5, provided that the true strain applied to the powder area is superior to the true strain applied to the shell.

6. A method according to claim 1, wherein the pressure inside the die cavity at the end of the forging operation is between 30 MPa and 400 MPa, more preferably between 100 MPa and 400 MPa, and more preferably between 100 MPa and 300 MPa.

7. A method according to claim 1, wherein the piece of metal alloy is of an alloy based on iron, aluminum, nickel, titanium, chromium, or cobalt.

8. A method according to claim 1, wherein the piece of composite materials is of a titanium-titanium carbide alloy, of an aluminum-alumina alloy, or of an aluminum-silicon carbide alloy.

9. A method according to claim 1, wherein the forging operation for forging the preform obtained by additive manufacturing is performed semi-hot or cold or hot.

10. Pieces or parts obtainable by implementing the method according to claim 1.
